(19) United States
(12) Patent Application Publication
(10) Pub. No.: US 2013/0020357 A1
(43) Pub. Date: Jan. 24, 2013

(54) Pre-Assembled Brick Well and Purging Block Assembly for Steel Ladle

(71) Applicants: Robert Brent Hatcher, Crawfordsville, IN (US); Robert Allen Wartman, Crown Point, IN (US)

(72) Inventors: Robert Brent Hatcher, Crawfordsville, IN (US); Robert Allen Wartman, Crown Point, IN (US)

(73) Assignee: FIRST CLASS MILL SERVICE INC., Michigan City, IN (US)

(21) Appl. No.: 13/250,406

(22) Filed: Sep. 30, 2011

Related U.S. Application Data
(60) Provisional application No. 61/509,719, filed on Jul. 20, 2011.

(51) Int. Cl. B22D 41/50; B32B 37/12

(52) U.S. Cl. 222/591; 156/330

(57) ABSTRACT

Pre-assembled brick assemblies for refractory installations used in steel production. A purging block or well block can be pre-assembled out of fire brick to exactly fit an opening for a particular ladle, and hence can be supplied in different sizes and shapes, and a full refractory ladle bottom can be manufactured that can include a pre-assembled purging blocks and pre-assembled well blocks with dimensions from the old bottom, thus providing a near-perfect fit. The pre-assembled brick blocks and/or the entire pre-assembled bottom can be held together with a high-strength epoxy while being assembled and installed. Purging blocks or well blocks can be directly installed in a well in a pre-assembled brick bottom.

This application is related to and claims priority from U.S. Provisional Patent Application No. 61/509,719 filed Jul. 20, 2011. application 61/509,719 is hereby incorporated by reference.

### BACKGROUND

1. Field of the Invention

The present invention relates generally to refractory for ladles used in steel manufacturing and more particularly to a pre-assembled ladle bottoms, brick wells and brick purging block assembles.

2. Description of the Prior Art

Very large ladles that are designed to heat and contain molten metal are used extensively in the manufacture of steel products. These ladles are typically made of steel and lined with fire bricks (refractory) and weigh several tons. They may have various diameters and depths with 10 feet in diameter and 12-13 feet in depth being representative. A example ladle can hold around 120 tons of molten steel (with each cubic foot of molten steel weighing around 430 lbs). Each of these ladles typically has one or more openings in the bottom. Prior art methods use a pre-cast refractory purging block sometimes called a pocket block inserted in these openings with a removable cast refractory lined, purge plug.

The generally round tapered purging blocks or well blocks vary in size but are typically around 15 inches in outer diameter with a plug hole of around 7 inches in diameter and a length of around 18 inches. These pre-cast blocks need to be periodically replaced. In order to remove the block, it is generally necessary to cool the ladle, force out the block, and then install a new pre-cast block. This can take several days. Cooling and re-heating is a very expensive process in the steel industry and requires a loss of production. Also, time when a ladle is cool is time lost. Prior art pre-cast refractory shapes such as purging blocks are cast in a molds. It would be extremely advantageous to have a purging block or well block that was not cast, but rather assembled from brick. The brick pieces can be of higher quality materials and are of higher densities compared to pre cast refractory shapes. A non-cast brick purging block or well block can be manufactured off-site and can be quickly installed. With the pre-assembled blocks being manufacturing out of the higher quality higher density material it is most likely the shapes will last the entire life of the refractory lining thus prolonging the life of the refractory lining of the ladle and decrease operating costs.

The complete refractory in all ladles must be periodically replaced. This is a major job that requires total cooling, removal of the old refractory and purging blocks and installation of new refractory and pre-cast purging blocks. It would be very advantageous to have a complete pre-manufactured full refractory bottom/sidewall lining that would fit into the entire bottom of the ladle and sidewall as a single piece. This could be manufactured off-site and simply lowered into the ladle for installation. All dimensions for the new bottom would come off of the steel shell dimensions. The fit would be perfect and only the remaining sidewalls would need to be bricked. Pre-assembled purging blocks and well blocks would already be installed in the ladle bottom.

### SUMMARY OF THE INVENTION

The present invention relates to pre-assembled brick assemblies for refractory installations used in steel production. A purging block or well block can be pre-assembled out of fire brick to exactly fit an opening for a particular ladle's bottom, and hence can be supplied in different sizes and shapes, and a full refractory ladle bottom can be manufactured that can include pre-assembled purging blocks and pre-assembled well blocks with dimensions from the old bottom, thus providing a near-perfect fit. The pre-assembled brick blocks and/or the entire pre-assembled bottom can be held together with a high-strength epoxy while being assembled and installed. Purging blocks or well blocks can be directly installed in a well in a pre-assembled brick bottom. Once the entire bottom with the installed blocks is installed in the ladle, and upon heating, the relatively thin epoxy layer burns out (in both the purging and well blocks and in the pre-assembled bottom/linings), and as the bricks expand from the heat up process, they press tightly together forming a tight, leak-proof unit of continuous brick that covers the bottom/sidewalls of the ladle.

It is an objective of the present invention to provide pre-assembled well block and purging block assembles that will have higher density and strengths then conventional pre-cast block assemblies.

It is another objective of the present invention to provide a pre-assembled well and purging block that increases refractory life and performance of the pre-assembled pieces thus allowing the customer to increase service life thus decreasing refractory cost.

It is another objective of the present invention to provide a pre-assembled well or purging block that can be customer-specific where the block can be manufactured with pressed refractory brick shapes and assembled together by using a high strength epoxy.

It is another objective to manufacture a pre-assembled bottom that includes the entire refractory lining within the ladle bottom (or alternatively the entire refractory of the ladle). This will decrease turn-around time and labor hours providing customer with additional savings.

It is an intention of the present invention to provide to the steel market with pre-bricked assemblies to extend the working life of that product. By manufacturing pre-bricked assembly shapes, a higher quality, higher density brick can be used to produce the shapes and the shapes can be assembled into useable products within the industry eliminating the need for conventional cast shapes that are unable to achieve the qualities and densities that the pre-bricked assemblies can achieve.

It is also an intention of the present invention to expand on this process by making larger pre-bricked assemblies that currently the industry installs piece by piece thus eliminating the down-time of the vessel in which the brick pieces are installed

### DESCRIPTION OF THE FIGURES

Several drawings are presented to illustrate features of the present invention:

FIGS. 1A-1B shows a prior art pre-cast purging block.

FIG. 2A-2B shows a prior art purging plug.

FIG. 3 shows a side sectional view of a ladle with holes for pre-cast or pre-assembled blocks.

FIG. 4 shows an embodiment of a pre-assembled brick purging block according to the invention with a rectangular hole.

FIG. 5 shows an embodiment of a pre-assembled brick purging block according to the invention with a round hole.

FIG. 6 shows a detail of refractory in a ladle.

FIG. 7 shows a pre-assembled total refractory bottom for a ladle containing wells according to the present invention.

Several drawings and illustrations have been presented to aid in understanding the present invention. The scope of the present invention is not limited to what is shown in the figures.

### DESCRIPTION OF THE INVENTION

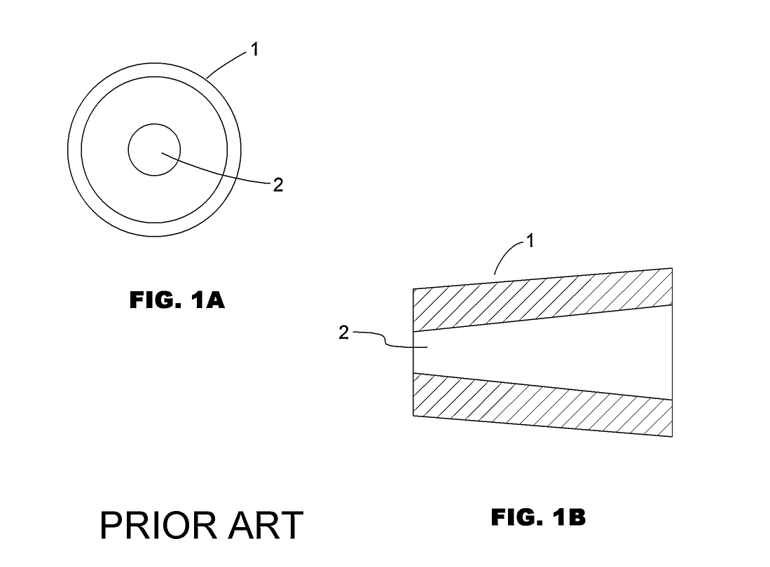

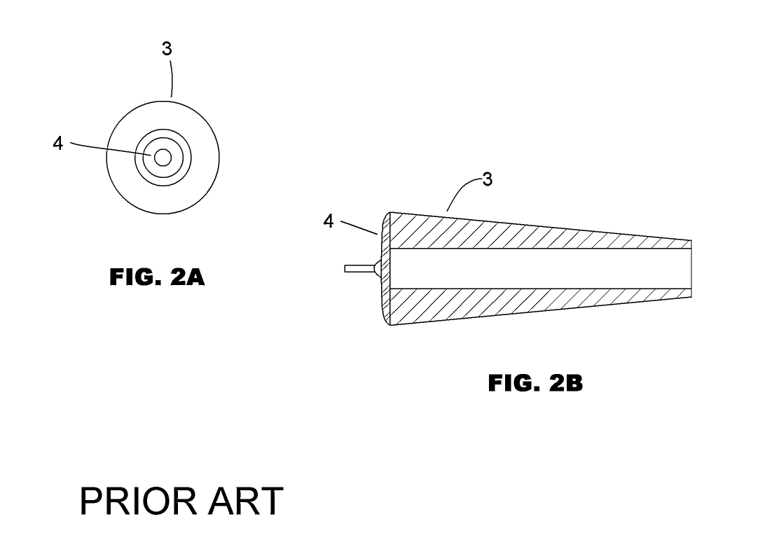

The present invention relates to pre-assembled brick purging blocks and well blocks as well as complete ladle bottom refractory assemblies for ladles containing pre-assembled blocks. Turning to FIGS. 1A-1b, a cross-sectional view of a prior art pre-cast purging block can be seen. Typically the block 1 contains a cast hole 2. FIGS. 2A-2B show a cross-section of a smaller cast block 3 and plug 4. It can be seen from FIGS. 1A-2B, that the exterior shape of the cast block is round. This shape does not result in a good match with the refractory brick pattern in the bottom of the ladle which is generally stepped due to the bricks being rectangular. Since refractory bottoms for ladles may be pre-assembled, they must be supplied with irregular wells into which the pre-cast prior art blocks are inserted. Then the irregular voids must be filled.

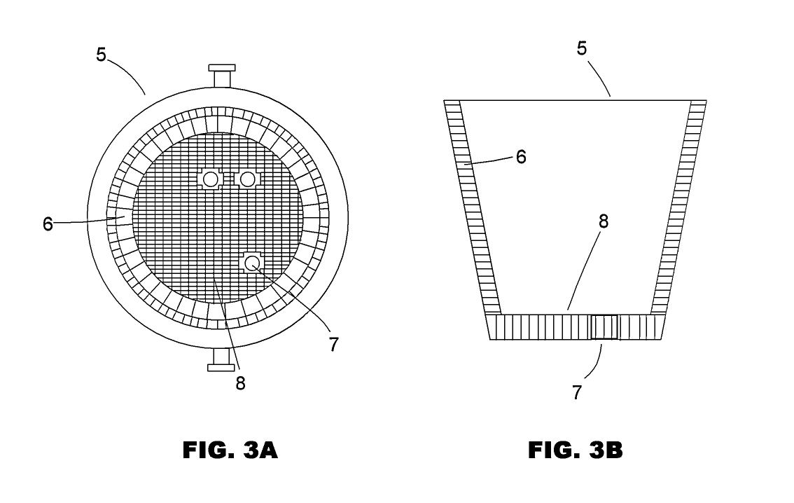

FIGS. 3A and 3B show sectional views of a ladle 5 and of the refractory lining 6,8 used in ladles. FIG. 3A is a top-down view, while FIG. 3B is a side view. The irregular brick patterns around the wells and purging hole 7 can be seen in FIG. 3A.

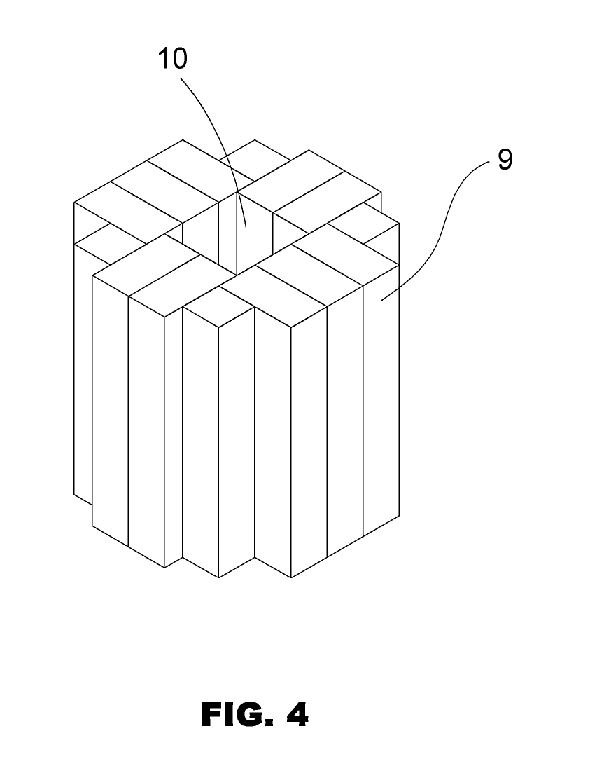

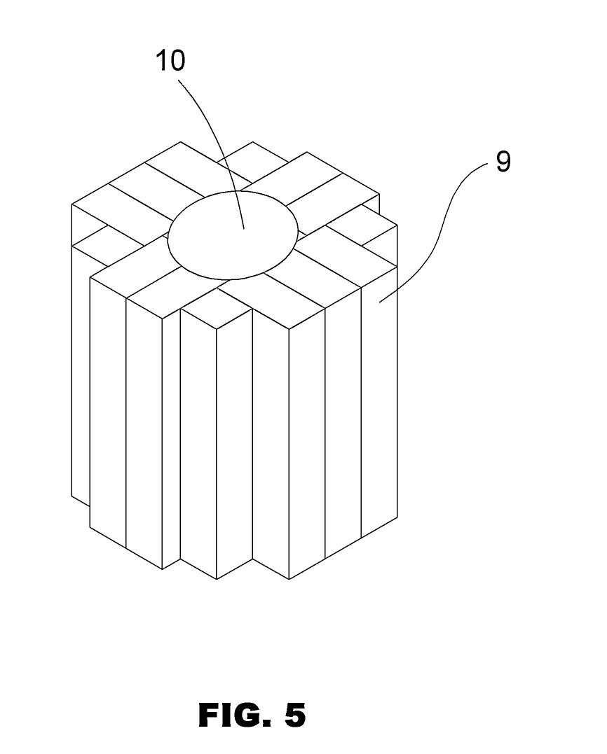

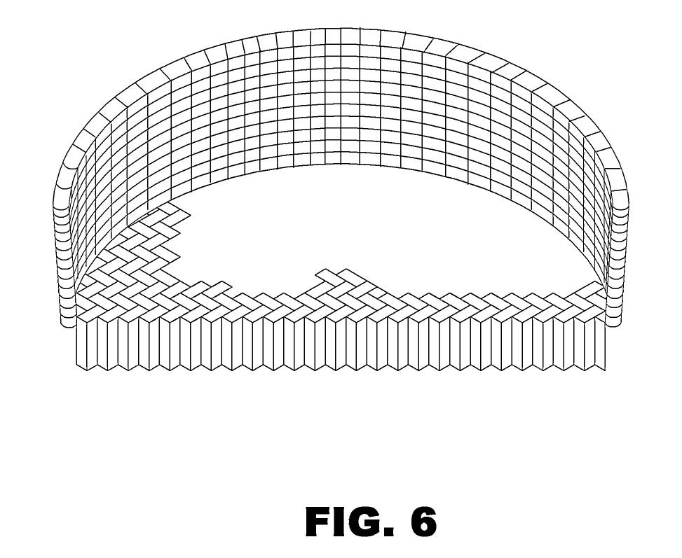

FIG. 4 shows an embodiment of the present invention, namely a pre-assembled brick purging block 9 with a brick pattern that will match the mating brick pattern around a pre-assembled well in a refractory bottom. The embodiment of FIG. 4 has a rectangular center hole 10. FIG. 5 shows an embodiment with a circular canter hole 10. To create a purging block or well 9 according to the present invention, bricks are stacked and attached to one-another with epoxy to form the block shape or well shape shown in FIGS. 4-5. The entire well/block assemble can be made to match the predetermined brick pattern of a pre-assembled ladle bottom refractory layer 8 (shown in FIG. 3). as previously stated, the purging block 9 typically is created with a generally round or rectangular hole 10 in the center that runs from top to bottom sized to receive a standard purge plug such as that used with FIG. 2. A typical outer shape for the purging block and well is a stepped hexagon or some other symmetric geometric shape. Such a shape can be seen in FIGS. 4-5. Usually rectangular bricks can be used; however, in some cases, the bricks can be cut to different shapes, or different sizes of bricks can be used. The stepped shape matches the brick pattern of the well so that the roughly plug-shaped block fits directly into the well in the pre-assembled refractory floor. The entire refractory floor for the ladle with the wells and purging blocks can then be supplied to a customer as a single integral unit. A detail of refractory used in a ladle can be seen in FIG. 6

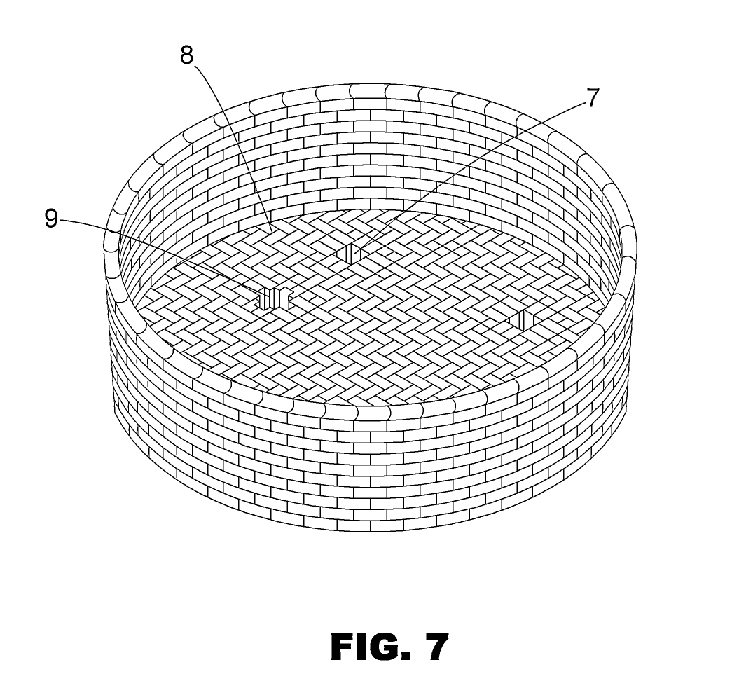

FIG. 7 shows a pre-assembled ladle refractory floor with wells according to the present invention showing prepared holes in the bottom 8. The holes 7 are rectangular, while the holes 9 are hexagonal. The entire floor assembly can be assembled and held together with epoxy. Pre-assembled well blocks and/or purging blocks can be made individually to exactly match the well holes 7, 9 in the floor 8. These are also held together with epoxy. When the all the epoxy has cured, the block assemblies can be epoxied into the wells in the floor. This results in a total assembly that can be very quickly installed in a ladle.

As previously stated, once the entire bottom with the installed blocks is installed in the ladle, and upon heating, the relatively thin epoxy layer burns out (in both the purging and well blocks and in the pre-assembled bottom), and as the bricks expand from the heat up process, they press tightly together forming a tight, leak-proof unit of continuous brick that covers the bottom of the ladle.

The present invention provides a way to incorporate pre-assembled wells and purging blocks into the pre-assembled brick ladle bottom that will allow for both the pre-assembled well and purging blocks to be assembled into the pre-assembled brick bottom so that all shapes end up as a single piece. This process significantly reduces man-hours and allows for optimum refractory performance thus decreasing cost to the customer.

Several descriptions and illustrations have been provided to aid in understanding the present invention. One skilled in the art will realize that numerous changes and variations are possible without departing from the spirit of the invention. Each of these changes and variations is within the scope of the present invention.

We claim:

1. A method of providing pre-assembled ladle bottom comprising:
forming a pre-assembled ladle bottom remote from a ladle by attaching a plurality of refractory bricks together with epoxy to fit the ladle;
forming a well in the pre-assembled ladle bottom by omitting some bricks, said well having a predetermined irregular brick pattern;
forming a brick purging or well block that matches said irregular brick pattern in said well by attaching a second plurality of bricks together with epoxy;
providing a plug hole in said purging or well block adapted to receive a plug;
mounting said purging or well block into the well in said pre-assembled ladle bottom using epoxy;
supplying said pre-assembled ladle bottom refractory with said purging or well block as a single unit for installation in a ladle.

2. The method of claim 1 wherein said well has a stepped hexagonal shape.

3. The method of claim 1 wherein said plug hole is round.

4. The method of claim 1 wherein said bricks are fire bricks.

5. The method of claim 1 wherein said bricks are generally rectangular.

6. A method of supplying a pre-assembled purging or well block for a pre-assembled ladle bottom comprising:
constructing a purging or well block from a plurality of refractory bricks using epoxy to hold said bricks together, said purging or well block matching a well with a predetermined well shape in an pre-assembled ladle bottom;
making a plug hole in said block.

7. The method of claim 6 further comprising installing said purging or well block into said well with epoxy.

8. The method of claim 6 further comprising fitting a plug to said plug hole.

9. The method of claim 6 wherein said plug hole is round.

10. A pre-assembled refractory ladle floor comprising:
a plurality of refractory brick epoxied together to form a ladle floor; at least one irregularly shaped well in said ladle floor;
a pre-assembled purging or well block made from a plurality of refractory brick epoxied together having an irregular shape that matches the shape of the well in said ladle floor;
wherein said pre-assembled purge or well block is epoxied into said well in said ladle floor.

11. The pre-assembled refractory ladle floor of claim 10 further comprising a hole in said purging or well block.

12. The pre-assembled refractory ladle floor of claim 11 wherein said hole is round.

13. A pre-assembled well or purging block for a ladle floor comprising a plurality of refractory brick epoxied together having an irregular shape that matches the shape of a well in a pre-assembled ladle floor.

14. The pre-assembled well or purging block of claim 13 further comprising a plug hole in said well or purging block.

15. The pre-assembled well or purging block of claim 14 wherein said hole is round.
